(19) United States
(12) Patent Application Publication
(10) Pub. No.: US 2009/0313170 A1
(43) Pub. Date: Dec. 17, 2009

(54) Agent for Medical Image Transmission

(75) Inventors: Michael Goldner, Natick, MA (US); Abraham Gutman, Chestnut Hill, MA (US)

Correspondence Address: Sunstein Kann Murphy & Timbers LLP, 125 SUMMER STREET, BOSTON, MA, 02110-1618, US

(73) Assignee: AGMEDNET, INC., Boston, MA (US)

(21) Appl. No.: 12/485,864

(22) Filed: Jun. 16, 2009

Related U.S. Application Data
(60) Provisional application No. 61/061,872, filed on Jun. 16, 2008.
(60) Provisional application No. 61/106,504, filed on Oct. 17, 2008.

(51) Int. Cl. G06Q 50/00; G06Q 10/00; H04L 9/00; G06F 15/16; G06F 3/048

(52) U.S. Cl. 705/50; 705/7; 705/2; 709/218; 709/247; 715/779

(57) ABSTRACT

A downloadable agent facilitates medical image transmission in accordance with a clinical trial protocol. The agent includes program code for obtaining or receiving a medical image from a computer storage device or a DICOM-compliant diagnostic instrument, program code for accepting textual information about the patient or medical image and associating the textual information with the medical image to prevent dissociation of the textual information and the medical image, program code for executing a data compliance protocol, program code for encrypting the image and textual information and for compressing at least the image, and program code for transmitting the encrypted image and textual information across a wide area network to a remote translator for decompressing, de-encrypting and viewing of the image and textual information. The data compliance process prohibits inclusion of patient identity information in the associated textual information and medical image.

### CROSS REFERENCE TO RELATED APPLICATIONS

This application claims priority from U.S. provisional patent application No. 61/061,872, filed on Jun. 16, 2008, Bromberg & Sunstein LLP attorney docket number 3030/103, and U.S. provisional patent application No. 61/106,504, filed Oct. 17, 2008, Bromberg & Sunstein LLP attorney docket number 3030/104. The entire disclosure of each is hereby incorporated by reference herein.

### TECHNICAL FIELD

The present invention relates to the gathering, transport, distribution and quality assurance of diagnostic images and associated information, and more particularly to handling such data in the context of clinical trials.

### BACKGROUND

The introduction of a new medicine, medical device, or diagnostic test often demands a clinical study. Such studies being inherently expensive, loss of patient data is unacceptable. Because doctors and patients involved in such studies may be located on varying parts of the globe, data must be transported. For studies that involve diagnostic images, such as radiological data produced by a DICOM-compliant modality (e.g., certain magnetic resonance imaging or computed tomography machines), the image data is typically in a digital format. Accordingly, a widely used manner for transporting such images has been by express mail of an optical disc (CD-ROM) containing the data.

For use in a clinical study, the images usually must be associated with additional information about the patient and/or the image. This additional information is often entered on a paper form (“a transmittal form”) and the form express-mailed together with the images on a compact disc. There is a risk, however, that the paper and compact disc will become disassociated or wrongly associated at the site of the data generation, or at a central data repository (i.e., an “imaging core lab”).

Additionally, in clinical trials, there may be governmental and trial-specific rules and procedures that require non-inclusion of certain information prior to transmission. These rules are designed to protect the identity of the patients and to prevent bias in the analysis of the data. This process of complying with such requirements is referred to herein as “de-identifying” the data and, depending on the context, may include preventing inclusion of identifying information, actively removing identifying information prior to further processing, or modifying the data to comply with both government regulations and the clinical trial protocol being followed.

Due to the requirement for quality-checking and ensuring compliance with protocols and regulations, including deidentifying data, the endeavor of running a central data repository or core lab for studies involving medical images is highly labor intensive and expensive.

Poor interoperability of image transmission protocols may be inconvenient to patients attempting to share medical images with health care providers, to doctors attempting to transmit images to other doctors for purposes of obtaining a second opinion, and to primary responders attempting to transmit images to a trauma center ahead of an emergency transportation of a patient (e.g., a medical helicopter flight).

### SUMMARY OF THE INVENTION

In an embodiment of the invention, there is a computer program product for use on a computer system. The program code facilitates medical image transmission in accordance with a clinical trial protocol and includes a tangible computer usable medium having computer readable program code. The computer program product includes program code for receiving a patient's medical image from a computer storage device or a DICOM-compliant diagnostic instrument. The computer program product also includes program code for accepting textual information about one or both the patient and the medical image, and for associating the textual information with the medical image to prevent dissociation of the textual information and the medical image. The computer program product further includes program code for executing a data compliance protocol for ensuring that the associated textual information and medical image satisfy a clinical trial specific workflow. The data compliance protocol operates to prohibit inclusion of patient identity information in the associated textual information and medical image. The computer program product also includes program code for encrypting the image and textual information and for compressing at least the image, and program code for transmitting the encrypted image and textual information across a wide area network to a remote translator for decompressing, de-encrypting and viewing of the image and textual information.

Further features of related embodiments may be included individually or in combination. For example, the computer program product may include program code for executing a data compliance protocol including program code for removing information that identifies the patient prior to transmitting. The computer program product may include program code for executing a data compliance protocol that further includes program code for displaying the completion status of at least one of encrypting and removing information that identifies the patient prior to transmitting. The program code for transmitting may include program code for routing the image and textual information to a destination associated with the compliance protocol. The computer program product may include program code for applying a particular data compliance protocol based on a selection of protocols by a user. The computer program product may include program code for providing a graphical user interface having a protocol field for selecting one of a plurality of data compliance protocols. The computer program product may download the plurality of protocols from a server based on association of the computer with a plurality of clinical trials. The computer program product may include program code for creating audit data by associating at least one of a user identity and an execution time with at least one of obtaining, receiving, accepting, ensuring, encrypting, compressing and transmitting, and forwarding the audit data to an audit data storage device.

The computer program product may also include program code for removing information that identifies the patient prior to the transmitting and program code for creating audit data by linking at least one of a user identity and an execution time with the removing information. The program code for executing a data compliance protocol may be extensible and accept a data compliance module for increasing data compliance functionality.

The computer program product may include program code for checking a correspondence between anatomical features presented in the medical image and those required by the data-compliance protocol. The computer program product may include program code for checking that the accepted image was obtained in a proper time window that is in accordance with the data compliance protocol. The computer program product may include program code for checking patient information against a remote database to determine if the patient is enrolled in a clinical trial prior to transmitting the image and textual information associated with the patient.

In accordance with another embodiment of the invention, a method of distributing a diagnostic imaging study includes downloading a first transmitting translator computer program code for use on a first transmitting translator computer system on a first local area network, receiving, at the first transmitting translator computer system, the diagnostic imaging study from a local image source, compressing and encrypting the diagnostic imaging study using the first transmitting translator, and transferring the compressed and encrypted diagnostic imaging study to a first receiving translator for decompression and de-encryption. The program code includes program code for de-identifying patient identifying information prior to the transferring of the study.

Further features of related embodiments may be included individually or in combination. The diagnostic image study may be not stored or transferred unless it has been encrypted. The first translator computer program may be downloaded from a server via a wide area network. The image source may be selectable from at least one of a DICOM-compliant medical imaging system, a PACS, and an optical data storage reader.

The program code for removing patient identifying information may conform to a compliance protocol downloaded from a remote site. The compliance protocol may be executed on an investigator site and may be selected from a plurality of compliance protocols applicable to the investigator site. The compliance protocol may be selectable from a protocol field of a graphical user interface produced by the first transmitting translator computer program code.

In a related embodiment, the method may include generating audit information that includes at least one of a user identification and a time value associated with at least one of the receiving, compressing, transferring, or removing patient identifying information. In connection with this embodiment, the method may include transferring to and storing the audit information on a remote server.

In another related embodiment, the method also includes downloading a second transmitting translator computer program code for use on a second transmitting translator computer system on a second local area network, receiving, at the second transmitting translator computer system, the diagnostic imaging study from a local image source from one of a DICOM-compliant medical imaging system, a PACS, and an optical data storage reader; compressing and encrypting the diagnostic imaging study in the second transmitting translator, and transferring the compressed and encrypted diagnostic imaging study to the first receiving translator or to a second receiving translator.

In yet a further embodiment, there is a method of processing clinical trial information for transmission across a network. The method includes displaying a graphical user interface on a display device, having a protocol field for selecting one of a plurality of trial protocols stored in a memory device. The graphical user interface has an image retrieval field for selecting a medical image from a computer device or DICOM-compliant device. The method further includes using the protocol field to select one of the plurality of trial protocols, using the image retrieval field to select a medical image from a computer device or DICOM-compliant instrument, retrieving the medical image, displaying indicia on the user interface for prompting the entry of textual information related to the medical image that is required by the selected trial protocol, associating the textual information with the medical image, checking the textual information to determine if it is de-identified in accordance with the selected trial protocol, and forwarding the textual information and medical image toward a remote point via a network.

Further features of related embodiments may be included individually or in combination. The method may include displaying indicia for de-identifying or verifying de-identification of the textual information in accordance with the selected protocol. The method may include encrypting both the de-identified textual information and medical image before forwarding. The checking may include checking the medical image to determine if it complies with the selected trial protocol. The method may include reinitiating the de-identification or formatting process if the textual information is determined not to be formatted or de-identified in accordance with the selected trial protocol. The method may include enforcing a correspondence between anatomical features presented in the medical image and those required by the data-compliance protocol. The method may include checking that the accepted image was obtained in a proper time window that is in accordance with the selected trial protocol. The method may include checking patient information against a remote database to determine if the patient is enrolled in a clinical trial prior to transmitting the image and textual information associated with the patient.

### BRIEF DESCRIPTION OF THE DRAWINGS

The foregoing features of the invention will be more readily understood by reference to the following detailed description, taken with reference to the accompanying drawings, in which:

FIG. 1 schematically shows one of a variety of types of networks that may transmit medical information in accordance with an embodiment of the invention;

FIG. 2 shows a process for manipulation and transmission of image and patient data in accordance with an embodiment of the invention;

FIG. 3 schematically shows the network in accordance with the embodiment of FIG. 1, further showing multiple remote sites;

FIG. 4 schematically shows the network in accordance with the embodiments of FIGS. 1 and 3, further showing an audit data repository;

FIG. 5 schematically shows a network diagram for an embodiment including a plurality of analysis labs;

FIG. 6 shows a workflow in accordance with an embodiment of the invention;

FIG. 7 is a screenshot showing a de-identification window in accordance with an embodiment of the invention;

FIG. 8 is a screenshot showing a window for entry of information for addition to a DICOM header, in accordance with an embodiment of the invention; and

FIG. 9 is a screenshot showing a window for entry of information in a format analogous to a paper transmittal form, in accordance with an embodiment of the invention.

### DETAILED DESCRIPTION OF SPECIFIC EMBODIMENTS

Illustrative embodiments of the present invention facilitate the transmission of medical images and associated patient data from remote sites to a central data repository for distribution and/or analysis. Specific embodiments include methods, systems and computer program code for ensuring that operators at remote sites perform a particular prescribed workflow (i.e., a specific set and/or sequence of steps related to data-handling) prior to transmitting the data, thereby improving the data quality received by a central data repository. The workflow may involve enforcing compliance of the data with a particular format. As a result, the cost of running such a repository may be reduced and the number of patients enrolled in a clinical trial may be reduced by avoiding data loss. The workflow may include de-identification steps.

Investigators may participate in multiple clinical trials. An embodiment of the invention provides program code that allows trial-specific workflow-enforcement to investigators participating in multiple clinical trials. For example, when submitting data for a first trial, the program code requires a workflow associated with the first trial. However, when submitting data for a second trial, the program code requires a workflow associated with the second trial. Three or more clinical trial workflows are also contemplated.

In another embodiment, an agent executes on a computer at a clinical trial site (an “investigator site”). The agent allows selection of a data handling protocol, which ensures compliance with a predetermined and downloadable workflow and/or transmission format. Audit data may be generated in connection with the workflow, and may be transmitted to a remote site.

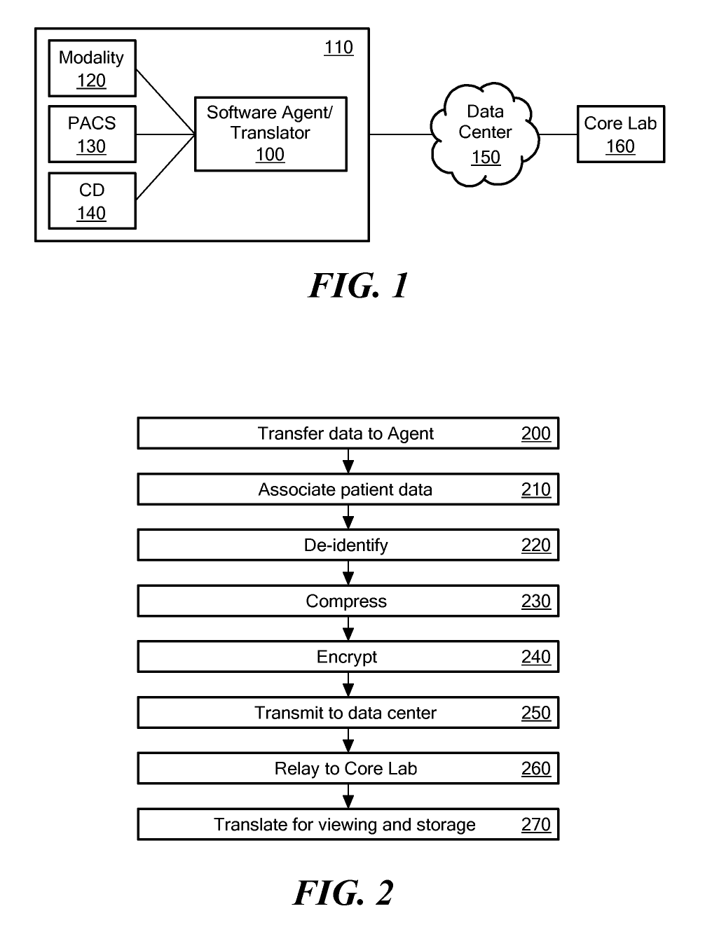

FIG. 1 schematically shows a network that may implement an illustrative embodiment of the present invention. An agent 100 is embodied in software running on a computer in a remote local area network (LAN) 110, such as may be found at a investigator site (e.g., a hospital, radiology department, clinic, or other imaging facility) engaged in recruiting and treating patients under a clinical trial protocol. The agent 100 software may be made readily available by providing it for download from a remote site. For example, the agent 100 software may be downloaded from the Internet by visiting a particular website and may be an executable file, an Internet-browser protocol compliance module, a JAVA applet, or the like. The agent 100 may be a small download (e.g., 10 MB or less).

As a result, the agent 100 may be implemented with minimal investment in hardware and minimal involvement of information technology professionals at the investigator site 110. The agent 100 may act as a “translator” to package data for transmission. An additional receiving translator agent may be utilized for unpacking and viewing images and data in other parts of the network. Thus, when users in different parts of a network download compatible transmitting and receiving translators, interoperability is assured.

The agent 100 executes on a computer and may present a graphical user interface to a user. In an alternate embodiment, the agent 100 may be cached on the local system so that it does not need to be downloaded for each use. For simplicity, hereinafter, “agent 100” refers to the software or to the computer that is executing the software, depending on the context, as will be readily understood by one of ordinary skill in the art.

As discussed in more detail below, the agent 100 enforces a workflow and data transmission process that prepares one or more images obtained from within a local image source within the LAN 110 to an analysis site, such as core lab 160. The transmission may occur over a wide area network (WAN) via a data center 150. The source may be, for example, a modality 120 (e.g., an imaging device, including DICOM compliant imaging devices), PACS (Picture Archiving and Communication system) 130, or a discrete and transportable optical data storage medium and reader 140 (e.g., a CD-ROM, DVD, flash memory, USB-drive, or the like). As used herein, a “computer storage device” may refer to either a PACS 120 or medium and reader 140. At least one of these data sources will be present in the LAN 110 and in communication with the agent 100. In connection with DICOM-compliant devices, the term “DICOM” encompasses all past, present and future versions of the DICOM standard.

The agent 100 may function as a transmitting translator. With regard to transmission protocols, U.S. Patent Application Publications 2007/0223794 and 2007/0225921, hereby incorporated by reference in their entirety, disclose systems and methods useful for transporting diagnostic imaging studies. Other data transfer protocols known in the art may also suffice.

FIG. 2 illustrates a method for transmitting medical image data in accordance with an illustrative embodiment of the invention. The method is described with reference to the connectivity scheme of FIG. 1, but is useful in connection with the embodiments having other connectivities, including those described below. In preparing the data for transmission to the core lab 160, the agent 100 enforces and facilitates a prescribed workflow in accordance with a clinical-trial specific compliance protocol. The workflow may enforce compliance of the data with a particular format and/or sequence of operations. For example, the workflow may enforce formatting by rejecting certain types of data, demanding reinitiation of data entry or data manipulation steps, or refusing to transmit data until it has complied with the data compliance protocol. The agent 100 also may act as an intelligent router that is capable of sending studies through the network to authorized destinations (e.g., the appropriate core lab or sponsor site).

The process begins at step 200, which transfers data to the agent 100 (step 200). The agent 100 may accept local data from one or more sources. For example, medical image data may be “pushed” to the agent 100 from a networked modality 120, PACS 130 or storage device 140 (i.e., transfer is initiated at the site of the source). The medical image data may be a single image or multiple linked images (e.g., x-rays taken of a bone at multiple angles).

Rather than being pushed to the agent 100, the image data may be requested by, and imported to, the agent 100. For example, a user may enter instructions (e.g., using a mouse click and a graphical user interface) via the agent 100 to initiate transfer of an image file or associated patient data to the agent 100. Alternatively, data may be transferred automatically. For example, all data stored in a particular folder or associated with a particular identifier may be periodically transferred to the agent 100 in an automated sweep operation. Data may also be imported from a portable computer storage medium such as a CD-ROM, USB flash drive, or the like.

The process continues by linking, to the medical image, additional data describing the patient and/or the image (or images) (step 210). Among other things, this may include patient data such as age, health characteristics and status, and anatomical measurements. Data describing the image may also be included, such as the anatomical part imaged, time and location acquired, and operator notes. This data may be entered (e.g., typed as text or via voice-recognition software) by a user of the agent 100, or may be transferred from elsewhere on the LAN 110. The association between the image and the additional data may be substantially indelibly linked using techniques known in the art, including encrypting, digital signing, compressing, or inclusion of a checksum. Such linking helps ensure data fidelity and should prevent tampering. In one embodiment, encryption of a linked and encrypted study (as used herein, a “study” or an “exam” refers to a medical image and optionally associated textual information) prevents de-encryption if the data is altered prior to receipt.

Next, the process may de-identify the image with linked patient data (step 220). For example, the agent 100 may require or request removal or secure encryption of any data that could be used to determine patient identity. In any case, the de-identified and linked data may be compressed (step 230) and encrypted (step 240) to aid in efficient and secure transmission.

After preparing the data as noted above, the process transmits it to the core lab 160 via a data center 150 (steps 250, 260). A receiving translator at the core lab 160 then de-encrypts and decompresses the linked image and textual data to permit storage and viewing (step 270). Because of computational demands and economies of scale associated with potentially high volumes of transmissions to the core lab, the core lab 160 may employ a translator that is implemented in dedicated or customized hardware. Alternately, the core lab may employ a software-based receiving translator. The workflow may be performed in accordance with a data transmission protocol. The protocol may be specific for a particular clinical trial, or for clinical trials in general. Optionally, revised protocols may be transmitted to or grabbed by the agent 100, e.g., from the data center 150 or the core lab 160. Protocol revisions may also be pushed to the agents 100 via the WAN.

The study may be automatically (without human intervention) pushed from the agent 100 to the core lab 160 or other final destination repository. The automatic routing may occur when a user at the investigator site completes the workflow requirements. In order to ensure routing of the study to the proper destination, a destination code may be assigned to the protocol and appended to the transmitted study.

The agent 100 may include a variety of features designed to enforce compliance with a particular data transmission protocol. As a result, data should be transmitted more securely and efficiently to the core lab, and a portion of the data processing workload may be shifted to the remote sites. For example, the agent may transmit the information to the data center 150 or core lab 160 only after compliance with one or more of the de-identification, transmission and compression steps. If any one of those steps is omitted, then the user may receive a notification to complete that step before the agent 100 will transmit.

Moreover, the graphical user interface (GUI) of the agent 100 may provide visual cues to a user. As used herein, the GUI may be a single page display, a series of nested pages (e.g., accessible with the press of a key or mouse-button), or other visual interface known to those in the art and commonly referred to as a GUI. The GUI may also comprise a wizard. The cues may inform the user of which mandatory workflow steps have been or have not been completed, or prompt the user to perform a particular task. For example, radio buttons, check boxes, or text displays may inform the user of which steps (e.g., obtaining the image, de-identifying, encrypting, compressing, and/or transmitting) have or have not been completed (a “completion status”). The agent 100 may operate in either the wizard-mode, and provide a sequence of prompts to the user, or in expert mode, in which the user is not prompted, but is informed of the completion status of each task in the workflow. In an embodiment, the agent 100 may be switched between a wizard and an expert mode.

Additionally, the agent 100 may present a view of the images to be transferred on a computer monitor so that the user is certain that the correct image is being transferred, or that the image is of sufficient quality. The exhibited image may be a thumbnail image, i.e., a view that is compressed in size with respect to the actual image file. Where a workflow step requires the entry of data, strict field validation may be enforced to help ensure proper entry and formatting of the data.

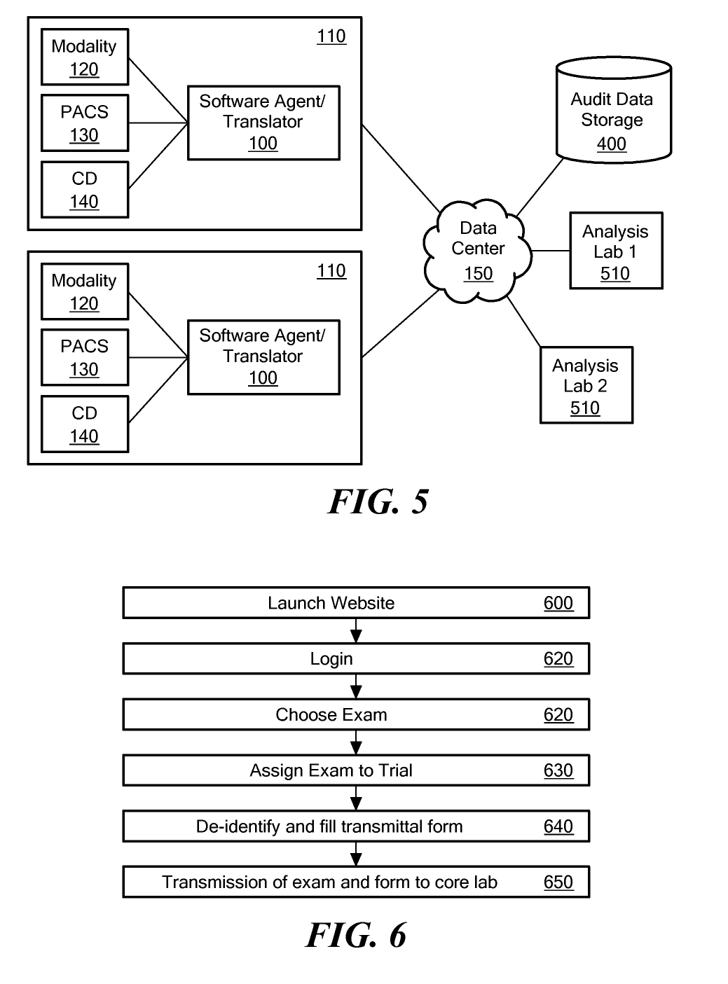

The agent 100 may allow access to a plurality of distinct selectable data compliance protocols, each associated with a different clinical trial. One of these multiple protocols may be selected via a protocol field of a user interface (e.g., buttons or a dropdown box in a GUI), depending on the desired destination or sponsor of the clinical trial study to be transmitted. These multiple protocols may be downloaded at various times, such as initially, periodically, or when accessed. The source of the protocols may be the data center 150 or other server. Protocols may be pushed to the agent 100. For example, when an agent 100 of an investigator site establishes a connection to the data center 150, protocols for which the investigator site is registered to participate in are downloaded to the agent 100. In this way, accurate and current protocols will be used and studies may only be routed to authorized destinations. By automatic managing available protocols in the agent 100, the network may also increase or reduce the number available protocols at an investigator site as the authorized participation of the site change. Where multiple core-labs or other analysis destinations are involved (see FIG. 5), each selectable protocol may include routing information for delivery of the image and associated data to the appropriate destination.

The agent 100 may also include a browser window, frame or tab for displaying instructions, clinical trial news, or other useful information.

In one embodiment, the agent 100 allows transmission of both DICOM and non-DICOM data (e.g., jpeg, bmp, or other format images). As disclosed in U.S. Patent Application Publications 2007/0223794 and 2007/0225921, the transmission of the images to the data center 150 and core lab 160 may use a protocol that is more efficient than DICOM.

In an embodiment, the agent 100 automatically enforces correspondence between anatomical features presented in the image and those required by the protocol. This may include rejecting or alerting a user to incorrect anatomical features of an image. For example, in a clinical trial studying osteoarthritis of the knee, the agent 100 will, based on a trial protocol, reject images of a hand or a head. This may be accomplished using pattern recognition or other image analysis techniques known in the art.

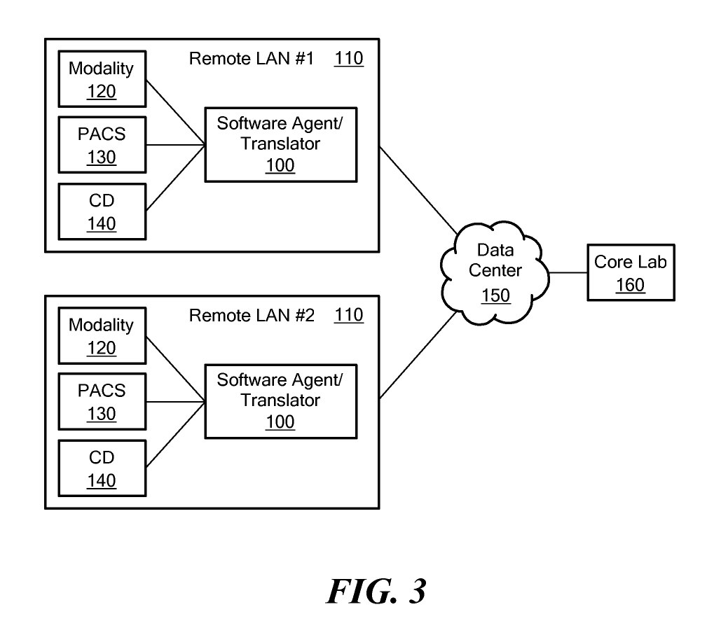

FIG. 3 shows a network schematic in which multiple investigator sites 110 are networked to a data center 150 and core lab 160. The investigator sites 110 may generate clinical trial data for a single or for multiple clinical trials. In addition, each remote site 110 also may have a distinct data compliance protocol.

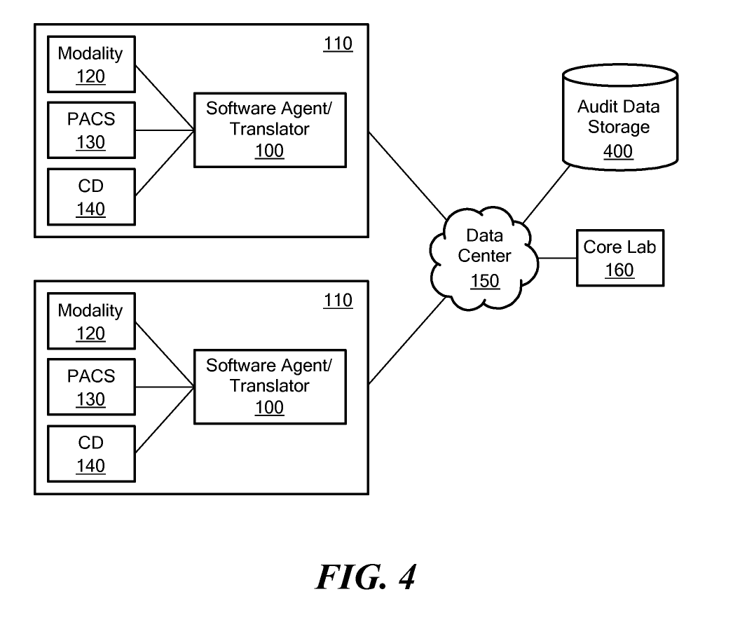

FIG. 4 shows a network schematic in accordance with an embodiment of the invention, which includes a data compliance audit system. When a data compliance step (e.g., steps 210 to 240 of FIG. 2) is implemented, the audit system records information about the completion of the step. For example, the agent 100 may record the logged-in user, time, and data file operated on for each step. Examples of loggable steps include obtaining or receiving an image, de-identifying, encrypting, compressing, and transmitting the image to the data center 150. This audit data may be transmitted to and stored at a remote site 400. The remote site may be integral to or linked with the data center 150 or the core lab 160. Audit data may later be used to ensure compliance, investigate irregularities, or to compute billable hours for contract services provided by remote sites associated with the LANs 110 associated with one or more of the aforementioned steps.

Among other things, alternate or additional audit information may include one or more of the following:

the sending institution,

sending modality/system,

type and size of study/case,

unique study,

accession number,

number of images, number of image series,

resolution parameters,

time stamps,

date,

hour:minutes:seconds,

user name,

time of login/logout operations performed,

forms filled,

routing destination, and

time of routing initiation.

FIG. 5 shows a network schematic in which multiple analysis destinations 510 receive image and associate data from the agents 100 via a data center 150. The analysis destinations 510 may be core-labs that serve one or more clinical trial sponsors, or may be sponsors themselves. Where multiple clinical trials are run by the institutions associated with the LANs 110, the routing of the images and associated information may be determined by the data compliance protocol selected. Multiple data centers 150 may also be included in the network for serving one or multiple sponsors. For example, each of multiple sponsors may be connected via a separate data center 150.

Additional security features may be employed in connection with the various embodiments of the invention. To that end, in one embodiment, data sources (120, 130, 140) can only transfer data to an agent 100 if the data source is registered and known to the network. In addition, agents 100 may only transfer data (e.g., to a destination repository such as a core lab 160 or sponsor lab 510 via the data center 150) if they are known and identified to the network. All operators may be logged in terms of username and time stamps for actions

In some embodiments, the agent 100 may reside within a firewall of the LAN 110. The agent 100 may also have its own active firewall. The agent 100 may accept traffic through only a single port and respond to only well-formed DICOM protocol requests from known, registered devices on the LAN 110. All communications from the LAN 110 to the data center 150 and beyond may be outbound-only and can only be initiated by the agent 100. The agent 100 may be configured so as not to require, and not respond to, any commands or queries originating anywhere, or from anyone, other than authorized users of systems on the LAN 110, and only if they have been authorized to send through the network.

The data center 150 may be similarly protected. In this instance, the data center 150 may only accept connections from registered agents 100. The data center 150 may reside behind redundant firewalls inside physically protected data centers with limited access using combinations of access cards and biometric access points. Within these data centers, servers may be physically enclosed in cages with secret access codes.

FIG. 6 shows a flowchart for a workflow in accordance with an embodiment of the invention. First, a user at a clinical site having a LAN 110 accesses a website (step 600). The website provides a software-based agent 100 (e.g., as an applet or protocol compliance module within a browser). The agent 100 may be downloaded, for example, from the data center 150. The user then logs-in to the agent 100 with a username and password. The user chooses an exam, i.e., a medical image or series of images of a study, (step 620). This may involve importing an exam from a modality 120, PACS 130, or storage medium 140. Alternately, the image has already been pushed to the agent from one of those sources. The exam is assigned to a trial (step 630). The assignment of the exam to a trial may involve selection among multiple trials be conducted at the clinical site. The selection may be via a dropdown window of GUI, choosing on of multiple buttons on a GUI, keypad entry, or other input means.

Selection of the trial determines the protocol to be used to guide a user through downstream workflow steps of de-identifying and completing the transmittal form (step 640) and the conditions required to allow or trigger transmission of the exam to the data center 150 and core lab 160. Lastly, the exam is transferred (step 650). For example, the exam may be selected from a list by a user with a point and click; the exam may then be uploaded by clicking on a button labeled “upload”. The destination of the exam may be determined by and encoded in the protocol. A pop-up box may than inform the user of upload progress. The network may be arranged to send a confirmatory e-mail to the user upon receipt of the image and transmittal information at the core lab 160. Additionally, delivery may be confirmed via access to an internet database informed by the data center 150 and/or core-lab 160.

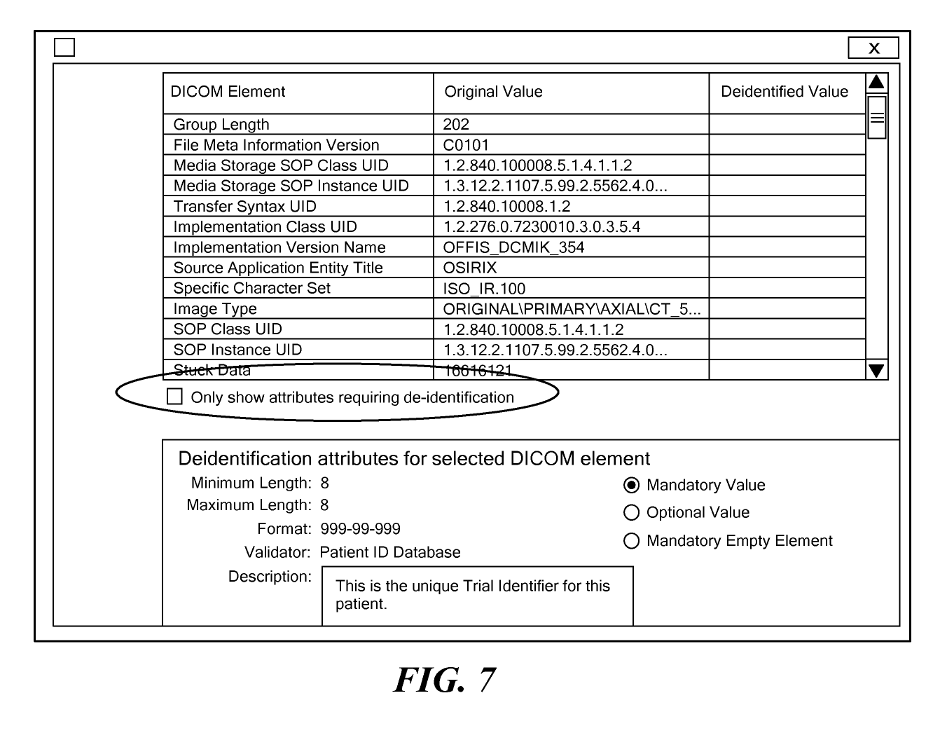

FIG. 7 shows a screenshot for an example of a de-identification workflow enforced by the agent 100 in connection with a trial-specific data compliance protocol, in accordance with an embodiment of the invention. After a user assigns an exam to a trial, the agent may present a de-identification window as shown, presenting DICOM-header fields that require changes. Optionally, a user may select an option to “Show all DICOM header fields.” Upon selecting a DICOM element, the agent 100 presents the user with instructions on how to edit the element to conform to a standardized format associated with the protocol. In FIG. 7, for example, such instructions are shown in the lower right-hand corner of the window and labeled “De-Identification attributes for selected DICOM elements.” Each field may be indicated as mandatory, optional, or mandatory empty. In other words, the data enforcement protocol will either require, permit, or require exclusion of particular DICOM fields. Additionally, the length and type of characters may be restricted to a range, a format can be specific, and the input value may be checked against an external database such as the sponsor's patient number list. These requirements may be different for each trial protocol. To enforce proper de-identification, the user must successfully complete each required field before being able to proceed toward completing the workflow specified by the trial protocol.

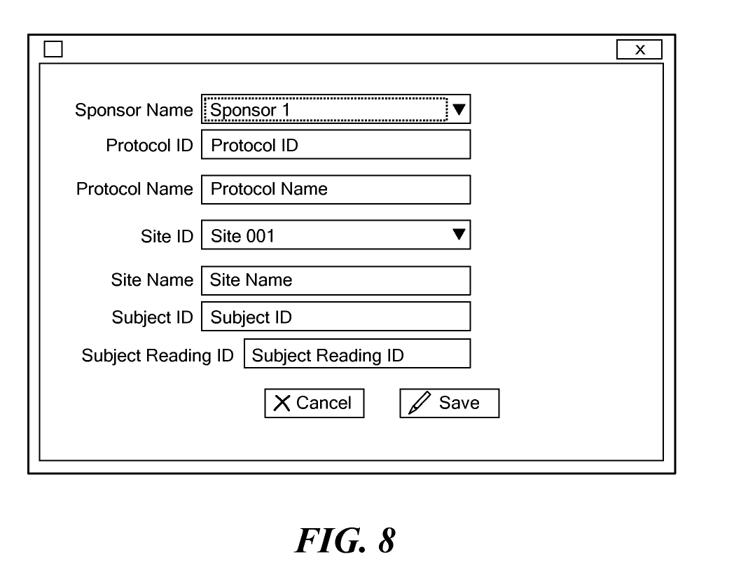

FIG. 8 shows a screenshot of a data entry window for adding additional textual information to the DICOM header, in accordance with an embodiment of the invention. Examples of information types that may be added include: the sponsor name, protocol identification number, protocol name, site identification number, site name, subject identification number, and a subject reading identification number. Depending on the information required by the clinical trial-specific data compliance protocol, asterisks or other indicia of requirement may be included next to a corresponding data-entry field.

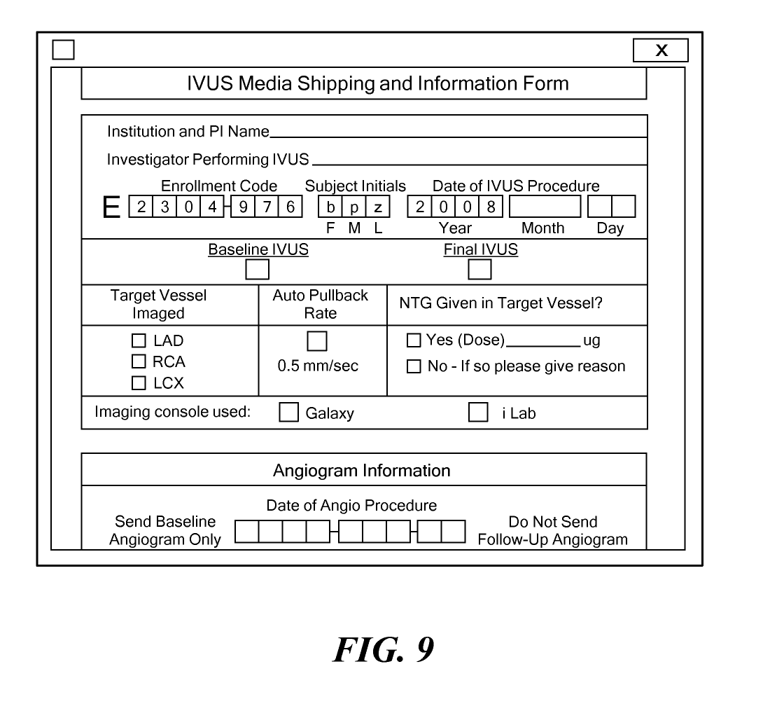

A clinical trial protocol may also require the completion of an electronic form that is similar to paper transmittal forms used for associating textual information with an image on a CD-ROM. FIG. 9 shows a screenshot of a window used for filling out such an electronic form, in accordance with an embodiment of the invention. The form may have required and non-required data entry fields. The form may also pre-populate fields. For example, data may be pulled from a DICOM header of an associated medical image or from data entered in a prior de-identification step; the data is automatically entered in the appropriate field. Data validation may be used; e.g., some fields may be restricted to certain values such as 4 numbers or 1 letter and 8 numbers. The description of these requirements may be viewed by pointing a mouse over a corresponding field.

Dynamic fields may be used; selecting a value in a dynamic field will then produce new values in the form. A common example of this is a trial that has two exam types. The first field of the form will be exam type. After selecting the exam type, new form fields will be introduced.

In an embodiment, textual information that has already been uploaded to the data center 150 may be later edited. In order to comply with government regulations, this operation may require identification of the user making the changes and an entry of a reason for the change.

In an embodiment, a protocol or a user may elect that status notifications be sent to the user or to another. Optionally, one or more of a plurality of notifications may be selectable by the user. Some example notifications follow:
A user may be notified when an agent beings transmitting a study to the data center 150. This notification is triggered when a study's images begin to transit through the network core.
A user may be notified when a study finishes transmitting to the data center 150.
A user may be notified when an error occurs in transmitting to the data center 150. The network may be designed to queue studies and retry transmissions in the event that either the sender or receiver is shut off for a period of time or if communication is interrupted. This error notification indicates that a study has been in transit for over a specified period (e.g. 24 hours). This can occur if the sending agent is shut down before the study has completed transmitting to the data center 150.
A user may be notified when a study begins transmitting from the data center 150 to the destination (e.g., sponsor 510 or core lab 160).
A user may be notified when a study finishes transmitting to the destination.
A user may be notified when an error occurs in transmitting from the data center 150 to the destination
A user may be notified when a transmittal form is ready to be filled out. This notification indicates that a study has been assigned to a trial that has a transmittal form in the workflow, and that transmittal form should now be completed.
A user may be notified when a transmittal form has been filled out.
A user may be notified when a transmittal form has been updated (i.e., modified and resubmitted).
A user may be notified when a transmittal form is incomplete.

The above-mentioned embodiments advantageously shift quality-control functions to the investigator site, thus reducing the amount of incomplete or erroneous data received at the destination. Further, the agent 100 may use an architecture that enables protocol compliance modules. The protocol compliance modules may allow extensibility of the agent 100 data validation functionality. The protocol compliance modules are similar to a browser protocol compliance module. However, unlike a typical internet browser protocol compliance module, the protocol compliance modules are not voluntarily selected by a user, but are mandated by the clinical trail protocol; e.g., via the core-lab. Accordingly, the protocol compliance modules may be selected pushed to and agent 100 via the network based on clinical trial participation.

For example, a protocol compliance module may perform image analysis or meta-data checking to ensure that the image is consistent with the body-part called for in a protocol. In other words, the protocol compliance module checks or allows the agent 100 to check that specific body parts are present or absent from the exam, and to initiate a specified course of action based on the finding. Possible courses of action include but are not limited to: preventing the data from being submitted; allowing the data to be submitted but flagging that data and requesting that the sender provide specific additional information; allow the data to be submitted but modifying subsequent steps in the submission workflow, or requiring the submission of future image exams by that user.

In another example, a protocol compliance module uses parameters established in the trial protocol to determine whether data being submitted follows strict patient visit rules envisaged by the trial. For example, a 3-year oncology trial testing a pharmaceutical compound may require that each patient be imaged every 6 weeks after their first set of images are taken at the time of recruitment (each of these imaging events is called in the art a “timepoint”). It is very important that this happen on a strict schedule. If the patient is imaged prior to the 6 weeks or after the 6 weeks, the data will be skewed: either the effect of the compound was not yet visible because the timepoint was premature, or the images were showing a greater effect because more doses were given prior to timepoint being taken. Because of the existence and difficulty in detecting such biases, clinical trials often have to use significantly more patients, at a much higher cost (due to increased trial length and recruitment expenses), to ensure that these events do not have a major statistical effect. A protocol compliance module to the agent 100 may automatically determine if images submitted where obtained within the proper time window (e.g., based on a data compliance protocol) and can take various actions depending on the result of this data quality test. For example, the data may be rejected or flagged as potentially non-compliant based on a timestamp associated with an image (e.g., DICOM metadata produced by a modality). Alternately, the above-described time-tracking functionality may be directly built into the agent 100 (i.e., without requiring a protocol compliance module).

In another example, a protocol compliance module uses real-time parameters to ensure that data from only the correct patients, enrolled in the correct trials, are submitted to the core lab for analysis, and ensures that the data for these patients (i.e., the images and ancillary information) is indelibly linked to the images. Use of this protocol compliance module may result in increased confidence that an analyzed image is indeed from a specific patient, and that patient is a validated subject of the trial. The data the protocol compliance module uses to perform this task includes queries to one or more remote databases owned and maintained either by the core lab, the sponsor or a third party that has been contracted by one of these parties them to maintain this data. The actions the protocol compliance module takes (e.g., prevention of data submission or flagging of potentially spurious data) may be determined based on a comparison of the data in a database and the information entered by the user at the investigator site. Alternately, the above-described patient-tracking functionality may be directly built into the agent 100 (i.e., without requiring a protocol compliance module).

In addition to the above-mentioned embodiments for use in clinical trials, embodiments of the invention may facilitate transmission of data for other purposes. For example, an agent may transmit image and other data to a second doctor for a second opinion, to a trauma center in advance of arrival of a trauma victim from a remote location, or to a medical device manufacturer for use in manufacturing of a customized prosthesis. In such applications, certain steps, such as de-identification, may not be necessary. The agent 100 may be configured so that this information is must be supplied before the agent will proceed to transmit the information beyond the site LAN 110.

The disclosed clinical trial management methods may be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The series of computer instructions embodies all or part of the functionality previously described herein with respect to the system. Those skilled in the art should appreciate that such computer instructions can be written in a number of programming languages for use with many computer architectures or operating systems.

The described embodiments of the invention are intended to be merely exemplary and numerous variations and modifications will be apparent to those skilled in the art. All such variations and modifications are intended to be within the scope of the present invention as defined in the appended claims. For example, patient consent forms may be included with the image and textual information.

What is claimed is:

1. A computer program product for use on a computer system for facilitating medical image transmission in accordance with a clinical trial protocol, the computer program product comprising a tangible computer usable medium having computer readable program code thereon, the computer readable program code comprising:
program code for receiving a patient's medical image from a computer storage device or a DICOM-compliant diagnostic instrument;
program code for accepting textual information about one or both the patient and the medical image, the program code for accepting including program code for associating the textual information with the medical image to prevent dissociation of the textual information and the medical image;
program code for executing a data compliance protocol for ensuring that the associated textual information and medical image satisfy a clinical trial specific workflow, the data compliance protocol operating to prohibit inclusion of patient identity information in the associated textual information and medical image;
program code for encrypting the image and textual information and for compressing at least the image; and
program code for transmitting the encrypted image and textual information across a wide area network to a remote translator for decompressing, de-encrypting and viewing of the image and textual information.

2. A computer program product according to claim 1, wherein the program code for executing a data compliance protocol further comprises program code for removing information that identifies the patient prior to transmitting.

3. A computer program product according to claim 2, wherein the program code for executing a data compliance protocol further comprises program code for displaying the completion status of at least one of encrypting and removing information that identifies the patient prior to transmitting.

4. A computer program product according to claim 2, wherein the program code for transmitting further comprises program code for routing the image and textual information to a destination associated with the compliance protocol.

5. A computer program product according to claim 1, further comprising program code for applying a particular data compliance protocol is based on a selection of protocols by a user.

6. A computer program product according to claim 5, further comprising program code for providing a graphical user interface having a protocol field for selecting one of a plurality of data compliance protocols.

7. A computer program product according to claim 6, wherein the plurality of protocols are downloaded from a server based on association of the computer with a plurality of clinical trials.

8. A computer program product according to claim 1 further comprising program code for creating audit data by associating at least one of a user identity and an execution time with at least one of obtaining, receiving, accepting, ensuring, encrypting, compressing and transmitting, and forwarding the audit data to an audit data storage device.

9. A computer program product according to claim 8 further comprising:
program code for removing information that identifies the patient prior to the transmitting; and
program code for creating audit data by linking at least one of a user identity and an execution time with the removing.

10. A computer program product according to claim 1, wherein the program code for executing a data compliance protocol is extensible and accepts a data compliance module for increasing data compliance functionality.

11. A computer program product according to claim 1, further comprising program code for checking a correspondence between anatomical features presented in the medical image and those required by the data-compliance protocol.

12. A computer program product according to claim 1, further comprising program code for checking that the accepted image was obtained in a proper time window that is in accordance with the data compliance protocol.

13. A computer program product according to claim 1, further comprising program code for checking patient information against a remote database to determine if the patient is enrolled in a clinical trial prior to transmitting the image and textual information associated with the patient.

14. A method of distributing a diagnostic imaging study, the method comprising:
downloading a first transmitting translator computer program code for use on a first transmitting translator computer system on a first local area network;
receiving, at the first transmitting translator computer system, the diagnostic imaging study from a local image source;
compressing and encrypting the diagnostic imaging study using the first transmitting translator; and
transferring the compressed and encrypted diagnostic imaging study to a first receiving translator for decompression and de-encryption,
wherein the program code includes program code for de-identifying patient identifying information prior to the transferring of the study.

15. A method according to claim 14, wherein the diagnostic image study is not stored or transferred unless it has been encrypted.

16. A method according to claim 14, wherein the first translator computer program is downloaded from a server via a wide area network.

17. A method according to claim 14, wherein the image source is selectable from at least one of a DICOM-compliant medical imaging system, a PACS, and an optical data storage reader

18. A method according to claim 14, wherein the program code for removing patient identifying information conforms to a compliance protocol downloaded from a remote site.

19. A method according to claim 18, wherein the compliance protocol is executed on an investigator site and is selected from a plurality of compliance protocols applicable to the investigator site.

20. A method according to claim 19, wherein the compliance protocol is selectable from a protocol field of a graphical user interface produced by the first transmitting translator computer program code.

21. A method according to claim 14, further comprising generating audit information comprising at least one of a user identification and a time value associated with at least one of the receiving, compressing, transferring, or removing patient identifying information.

22. A method according to claim 21, further comprising transferring the audit information to a remote server.

23. A method according to claim 22, further comprising storing the audit information on the remote server.

24. A method according to claim 16, further comprising:
downloading a second transmitting translator computer program code for use on a second transmitting translator computer system on a second local area network;
receiving, at the second transmitting translator computer system, the diagnostic imaging study from a local image source from one of a DICOM-compliant medical imaging system, a PACS, and an optical data storage reader;
compressing and encrypting the diagnostic imaging study in the second transmitting translator; and
transferring the compressed and encrypted diagnostic imaging study to the first receiving translator or to a second receiving translator.

25. A method of processing clinical trial information for transmission across a network, the method comprising:
displaying a graphical user interface on a display device, the graphical user interface having a protocol field for selecting one of a plurality of trial protocols stored in a memory device, the graphical user interface also having an image retrieval field for selecting a medical image from a computer device or DICOM-compliant device;
selecting, using the protocol field, one of the plurality of trial protocols;
selecting, from the image retrieval field, a medical image from a computer device or DICOM-compliant instrument;
retrieving the medical image;
displaying indicia on the user interface for prompting the entry of textual information required by the selected trial protocol, the textual information relating to the medical image;
associating the textual information with the medical image;
checking the textual information to determine if it is de-identified in accordance with the selected trial protocol; and
forwarding the textual information and medical image toward a remote point via a network.

26. A method according to claim 25, further comprising displaying indicia for de-identifying or verifying de-identificaton of the textual information in accordance with the selected protocol.

27. A method according to claim 25 further comprising:
encrypting both the de-identified textual information and medical image before forwarding.

28. A method according to claim 25 wherein checking further comprises checking the medical image to determine if it complies with the selected trial protocol.

29. A method according to claim 25 further comprising reinitiating the de-identification or formatting process if the textual information is determined not to be formatted or de-identified in accordance with the selected trial protocol.

30. A method according to claim 25, further comprising enforcing a correspondence between anatomical features presented in the medical image and those required by the data-compliance protocol.

31. A method according to claim 25, further comprising checking that the accepted image was obtained in a proper time window that is in accordance with the selected trial protocol.

32. A method according to claim 25, further comprising checking patient information against a remote database to determine if the patient is enrolled in a clinical trial prior to transmitting the image and textual information associated with the patient.
